(19) United States
(12) Patent Application Publication
(10) Pub. No.: US 2004/0234674 A1
(43) Pub. Date: Nov. 25, 2004

(54) Artichoke leaf extracts

(76) Inventors: Jurgen Eich, Ortsstrasse (DE); Thomas Haffner, Berlin (DE); Thomas Goerke, Berlin (DE); Werner Schneider, Eisenach (DE)

Correspondence Address: Scully Scott Murphy & Presser, 400 Garden City Plaza, Garden City, NY, 11530, US

(21) Appl. No.: 10/486,145

(22) PCT Filed: Aug. 7, 2002
(86) PCT No.: PCT/EP02/08838

(30) Foreign Application Priority Data
Aug. 8, 2001 (DE) 101 38 929.9

(51) Int. Cl. A23L 1/28

(52) U.S. Cl. 426/655

(57) ABSTRACT

The invention relates to artichoke leaf extracts (Cynarae folium) that are characterized by defined absolute percentages and relative inherent percentages of typical constituents of artichoke leaves such as caffeoyl quinic acids and flavonoids The activity spectrum of the inventive leaf extracts is substantially different from known artichoke leaf extracts, said inventive leaf extracts also being different from each other. The invention also relates to methods for producing the extracts and to fields of application thereof.

The invention relates to extracts from artichoke leaves (Cynarae folium), methods for their production and their use in various fields of application.

### PRIOR ART

Preparations made from artichoke leaves (Cynara scolymus L.) are widely used in the therapy of functional dyspeptic complaints. Juices pressed from fresh leaves and genuine aqueous und aqueous/alcoholic extracts (primary extracts) from fresh and dried leaves are used.

The choleretic (cholagogic) effect, the main mode of action for the treatment of functional dyspepsia, has been unequivocally proven for aqueous or alcoholic/aqueous primary extracts by means of in vitro and in vivo experiments and is considered to be scientifically established (Brand N. Cynara Monograph. In: Hänsel R, Keller K, Rimpler H, Schneider G. (ed): Hager's Handbuch der Pharmazeutischen Praxis, 5th edition, Vol 4: Drogen A-D. Springer Verlag, Berlin, Heidelberg, N.Y. 1992: 1117-1122; BRAND N. Zeitschr. Phytother. 1999; 20: 292-302]. These extracts are officially recognised for the treatment of dyspeptic symptoms (preparation monograph for Cynarae folium, Artischocken-blätter, BAnz 122, Jul. 6, 1988, in the corrected version in BAnz 164, Sep. 1, 1990).

With respect to the cited effects, the following constituent classes of artichoke leaves and their extracts are discussed as specific indicator substances and potential active substances: 1. mono-, di-caffeoylquinic acids (CQAs) and 2. flavonoids. It may be assumed that other, as yet unidentified, compounds could participate in the pharmacological and clinical activity spectrum of artichoke extracts and fractions of extracts. An analytical RP-HPLC gradient method may be used to separate and quantify the individual mono- and di-CQAs and the flavonoids from artichoke leaves and their extracts (BRAND and WESCHTA 1991, Zeitschr. Phytother. 1991; 12: 15-21). Four mono- and up to five di-CQA isomers and at least two flavonoids can be identified in the HPLC fingerprint chromatogram of aqueous artichoke leaf extracts. In this analytical method, the more strongly hydrophilic mono-CQAs elute first, followed by cynarine (1,5-di-CQA) and two to three flavone glycosides. These are followed by the remaining more lipophilic di-CQAs and, under some circumstances, smaller quantities of other flavone glycosides and flavone aglycones (FIG. 1). The quantification of the constituent classes is usually performed by means of summation, whereby the CQA content is calculated as chlorogenic acid (=mono-CQA) and the flavonoid content as luteolin-7-glucoside (=cynaroside).

In addition to the main principle of action of “increased choleresis”, there are indications that artichoke leaf extracts may have anti-cholestatic, anti-oxidative, cell-stimulating and cell-protecting effects as well as a favourable influence on lipid metabolism. These were obtained from in-vitro, animal and human pharmacological and clinical investigations (BRAND N. Zeitschr. Phytother. 1999; 20: 292-302; BRAND N. Cynara Monograph. In: HÄNSEL R, KELLER K, RIMPLER H, SCHNEIDER G (ed): Hager's Handbuch der Pharmazeutischen Praxis, 5th edition, Vol 4: Drogen A-D. Springer Verlag, Berlin, Heidelberg, N.Y. 1992: 1117-1122; EP-A-0958 828).

There are also data on the efficacy of artichoke leaf extracts in reducing the blood serum values of glucose, creatinine and bilirubin, for immunostimulation and the therapy of leucocytopenia, granulocytopenia, lymphocytopenia and bone marrow damage, for the treatment of diabetes and injuries caused by radiation or cytostatic agents during tumour therapy (DE-A-196 27 376; WO 98/01143; DE-A-198 50 543).

In vitro investigations of aqueous primary artichoke leaf extracts on rat hepatocytes and human HepG2 cells (hepatocytes) have shown a moderate, concentration-dependent inhibition of cholesterol biosynthesis caused by the indirect inhibition of HMG-COA reductase, the key enzyme in endogenic cholesterol biosynthesis. Aqueous primary artichoke leaf extracts have been clinically proven to have a moderate effect on the reduction of cholesterol and LDL values and to positively influence the HDL/LDL ratio (FINTELMANN V. Z. Allg. Med. 1996; 72: 48-57; KRAFT K. et al. Phytomedicine 1997; 4: 369-378; ENGLISCH W. et al. Arzneim.-Forsch./Drug Res. 2000; 50: 260-265; SIEDEK H. et al. Wiener klinische Wochenschrift 1963; 75: 460-463; SCH\ddot{ON}HOLZER G. Schweizerische Medizinische Wochenzeitschrift 1939; 69: 1288-1290). The constituents of artichoke leaves having an inhibitory influence on HMG-COA reductase activity have been identified as luteolin glycosides and free luteolin and 1,5-di-caffeoylquinic acid (cynarine) from the primary extracts by means of in vitro experiments on hepatocytes. However, the effect of these compounds when used for the therapy of humans is not known(GEBHARDT R. J. Pharmacol. Exp. Therap. 1998; 286: 1122-1128; GEHARDT R. Phytotherap. Res. 2001; 15: 1-5; GEBHARDT R. Medwelt 1995; 46: 348-350; EP 0 807 435 A2; Mars G. et al. Med. Welt 1974; 25: 1572-1574; PRISTAUTZ H. Wiener Med. Wochenzeitschr. 1975; 49: 705-709).

The aforementioned single compounds and other single compounds isolated from artichoke leaf extracts have been found to have pharmacological effects justifying the conclusion that they may be used for therapeutic applications with the indications named above and in the following (BRAND N. Zeitschr. Phytother. 1999; 20: 292-302; BRAND N. Cynara Monograph. In: HÄNSEL R, KELLER K, RIMPLER H, SCHNEIDER g (ed) : Hager's Handbuch der Pharmazeutischen Praxis, 5th edition, Vol 4: Drogen A-D. Springer Verlag, Berlin, Heidelberg, N.Y. 1992: 1117-1122; EP-A-0958 828). To date, none of the isolated substances has been used for the therapy of humans.

To summarise, it may be stated that a plurality of very different fields of application have been described for primary artichoke leaf extracts, such as, for example, applications for gastrointestinal diseases (for example dyspepsia), problems with lipometabolism, to increase cell protection in diabetics and tumour patients and for immunostimulation. However, the plurality of fields of application means that primary artichoke leaf extracts also have the undesirable property that the targeted therapy of defined diseases cannot take place without side effects in other areas of the organism.

Artichoke leaf preparations on the market contain exclusively primary artichoke leaf extracts with the above-described complex pharmacological and clinical action profile, but no “special extracts” with a “restricted” effect for targeted side-effect-free therapies (BRAND N. Zeitschr. Phytother. 1999; 20: 292-302). Prior art includes pressed juices, primary aqueous, methanolic and ethanolic extracts, of which the essentially only aqueous extracts in the form of dry extracts are commercially used primarily in solid drug forms (Table 1). In addition, ethanolic extracts are also used in liquid preparations (drops, juices). However, these are much less common.

The production of primary extracts generally occurs by exhaustive extraction from fresh or dried leaves at a high temperature. In the case of extraction with water, one part of extract generally requires 3 to 8 parts of drug or 20-40 parts of fresh leaves (water content of the fresh leaves: 80-90%). The extract yield depends on the quality of the leaves, the extraction conditions and the extraction agent used.

CQA contents of less than 6% for primary aqueous extracts may be considered to be prior art. Of this, 55 to 69% may be mono-CQA and 31 to 45% di-CQA, respectively. Depending on the quality of the drug, the flavonoid content of aqueous primary extracts is between 0.1% and 1% (Table 1).

TABLE 1
Total CQA and flavonoid contents and percentages of
mono, di-CQA of the total CQA content in aqueous artichoke
leaf dry extracts from commercial preparations (BRAND DAZ
1997; 137: 60-76) and our own results obtained using standard
methods.

| | | Percentage |
|---|---|---|
| | | of total CQA |
| Class of Compound | Content (%) | (%) |
| Total CQA | 0.37-4.71** | — |
| | 1.0-5.9* | — |
| Flavonoids | 0.13-0.51** | — |
| (for example scolymoside, | | |
| cynaroside, luteolin- | | |
| glucoronide, luteolin) | | |
| | 0.1-2.5* | — |
| Mono-CQA | 0.55-4.5* | 55-69* |
| (for example chlorogenic acid, | | |
| neo-caffeoylquinic acid, inter | | |
| alia chlorogenic acid isomers) | | |
| Di-CQA | 0.25-2.7* | 31-45* |
| (for example cynarine, 1,3-di- | | |
| CQA, inter alia di-CQA isomers) | | |

*own results using standard method
**commercial preparations (according to BRAND DAZ 1997; 137: 60-76)

To summarise, it may be stated that extraction with water or aqueous alcohols causes a quantitative enrichment of the CQA and flavonoids in the extract. However, the relative ratios of the compounds with regard to each other are virtually unchanged. Therefore, the conclusion may be drawn that the known complex pharmacological/clinical action profile for both the parent drugs and the aqueous or aqueous/alcoholic extracts produced therefrom should be qualitatively identical. Only the effective activity should be a function of the concentration of the compounds analysed.

The object of this invention is to distinguish between the different, sometime divergent action profiles of aqueous or alcoholic/aqueous primary extracts in order to ensure a targeted therapeutic application without any adverse side effects (for example a lipid-lowering action without an anti-dyspeptic action or vice versa). For this, primary extracts are divided using the method according to the invention into two extract fractions A and B, which have different activity spectra. Extract fraction A has a lipid-lowering and cell-protecting (anti-oxidative) action but no longer has the anti-dyspeptic action of the primary extract. Extract fraction B is clearly a more effective anti-dyspeptic agent than the primary extract, but now has virtually no lipid/cholesterol-lowering properties. Another object is to provide methods for the production of these extract fractions.

### SUMMARY OF THE INVENTION

A first aspect of the invention relates to an extract of artichoke leaves (Cynarae folium) containing: a total CQA content of mono-CQA and di-CQA of at least 6%, preferably 10 to 50%, relative to the total quantity of the extract and a flavonoid content of at least 3%, for example 4%, preferably 7 to 30%, relative to the total quantity of the extract. According to a preferred embodiment, the extract according to the invention has a mono-CQA content of less than 30%, for example from 3 to 30%, more preferably from 10 to 30%, relative to the total CQA content, in a further preferred embodiment, the ratio of mono-CQA content to flavonoid content is less than 1.

This extract according to the invention can be obtained using a method for the production of an aforementioned extract from artichoke leaves (Cynarae folium), which comprises the following steps:

liquid-liquid extraction of a primary extract from fresh or dried artichoke leaves obtained by extraction with water or by extraction with an organic solvent from the series of alcohols, ketones, esters, ethers, preferably methanol, ethanol or mixtures of these compounds with water, with an organic solvent from the series of alcohols, ketones, ester, ethers, aromatics or a mixture of these compounds, and

obtaining the organic phase.

A mixture of 2-butanol and ethyl acetate is used in particular according to the invention.

In a preferred embodiment, the method according to the invention is preceded by the following steps:

evaporation of the primary extract volume or addition of water to the primary extract until the extract contains more than 50% water.

washing the extract with a non-polar, water-immiscible solvent, preferably one from the series of alkanes, alkenes, ethers, esters or chlorinated hydrocarbons;

separation and disposal of the organic phase.

In a second aspect of this invention an extract of artichoke leaves (Cynarae folium)is prepared, which comprises: a total CQA content of mono-CQA and di-CQA of at least 1%, preferably 2-15%, relative to the total quantity of the extract, a flavonoid content of a maximum of 2%, preferably 0.02-1.5%, relative to the total quantity of the extract and a content of mono-CQA of at least 70%, for example 75%, relative to the total CQA content. The ratio of mono-CQA content to flavonoid content is hereby preferably between 4 and 35, for example between 5 and 35.

This above-mentioned extract can be produced from artichoke leaves (Cynarae folium) using the following method comprising the steps of:

liquid-liquid-extraction of a primary extract from fresh or dried artichoke leaves obtained by extraction with water or by extraction with an organic solvent from the series of alcohols, ketones, esters, ethers, preferably methanol, ethanol or mixtures of these compounds with water, with an organic solvent from the series of alcohols, ketones, esters, ethers, aromatics or a mixture of these compounds, and

obtaining the aqueous phase.

In preferred embodiments, the organic solvent for the extraction of the primary extract is a mixture of 2-butanol and ethyl acetate, and the method may additionally be preceded by the following steps:

evaporation of the primary extract volume or addition of water to the primary extract until the extract contains more than 50% water.

washing the extract with a non-polar, water-immiscible solvent, preferably one from the series of alkanes, alkenes, ethers, esters or chlorinated hydrocarbons;

separation and disposal of the organic phase. The above extracts can be used for the production of medicinal products, foodstuffs, dietetic foods and cosmetics.

According to the invention, the first mentioned extracts have an anti-oxidative, cell- and organ-protective action and may be used for the treatment and prevention of hypercholesterolaemia and hyperlipidaemia, for the treatment and prophylaxis of cardiovascular diseases and arteriosclerosis and dementia.

The extracts according to the second aspect of the present invention have an anti-serotonergic, spasmolytic, anti-cholestatic, choleretic, anti-emetic, prokinetic action and may be used to increase vesicular secretion and lipolysis, for the treatment of dyspepsia and for the treatment of IBS (irritable bowel syndrome).

Both extracts are characterised by the fact that they have the relevant effects without any undesirable side effects.

### BRIEF DESCRIPTION OF THE FIGURE

FIG. 1 shows a typical RP-HPLC chromatogram of an aqueous, primary artichoke leaf dry extract.

### DETAILED DESCRIPTION OF INVENTION

The invention is based on the surprising finding that according to the invention, aqueous or aqueous/alcoholic primary extracts may be separated into two different fractions by extractive liquid-liquid fractionation with non-aqueous extraction agents, such as organic solvents, such as alcohols, ketones, esters, ethers, aromatics, e.g. aliphatic alcohols or carboxylic acid esters or mixtures thereof. The two fractions clearly differ from one another, for example with regard to the absolute and relative content of mono-CQA, di-CQA and flavonoids and in their pharmacological activity profiles. The constituents of the extracts which can be obtained by evaporating the extraction agent loaded after extraction will be referred to jointly as “extract fraction A” in the following. The constituents which remain in the aqueous phase will be referred to jointly as “extract fraction B”.

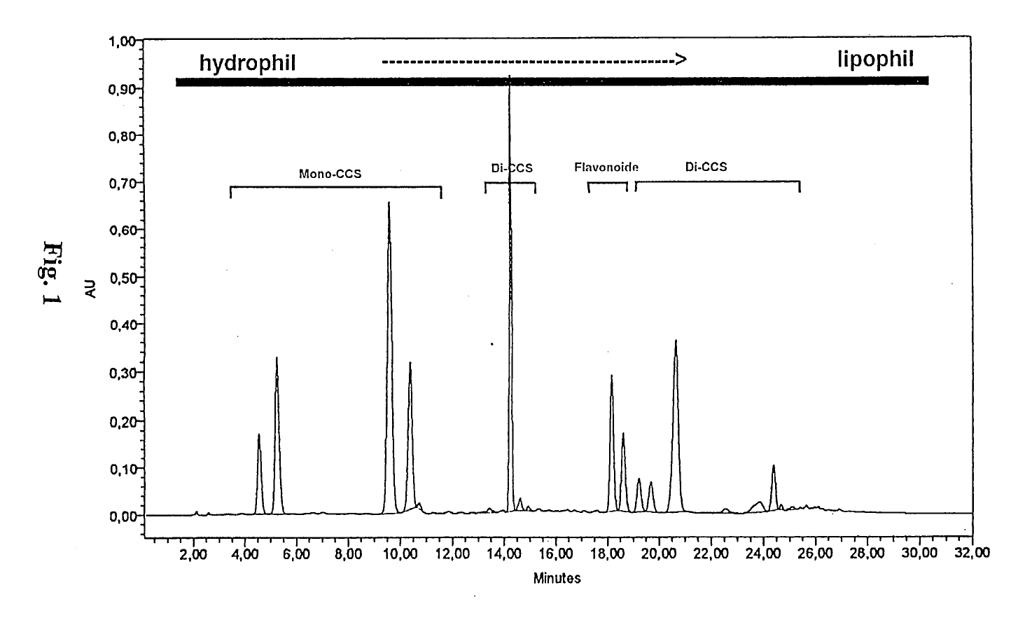

Extract fraction A according to the invention is characterised by the enrichment of more lipophilic or depletion of more hydrophilic compounds of the primary extract, respectively. This enrichment or depletion is expressed by a clearly reduced mono-CQA content and a greatly reduced mono-CQA/flavonoid quotient (see FIG. 1 and compare Table 3 with Table 7). A total CQA content of at least 6%, usually from 10 to up to 30%, can usually be found when using aqueous primary extracts and of at least 6%, preferably at least 10%, particularly preferably 15-50%, when using alcoholic/aqueous primary extracts. Regardless of the type of primary extraction agent, the mono-CQA content of the total CQA of this fraction is depleted to less than 30%, for example 3 to 30%, preferably 10 to 30%, as compared to the primary extract. The flavonoid content of extract fraction A is at least 3%, for example at least for aqueous and for alcoholic/aqueous primary extracts, preferably 7 to 20% for aqueous and alcoholic/aqueous primary extracts. The mono-CQA/flavonoid quotient in fraction A is reduced according to the invention to values of less than 1 as compared to aqueous and alcoholic/aqueous primary extracts.

Extract fraction B according to the invention is characterised by the depletion of more lipophilic or the enrichment of more hydrophilic compounds, respectively. This depletion or enrichment is expressed by a clearly increased mono-CQA content and a greatly increased mono-CQA/flavonoid quotient (see FIG. 1 and compare Table 3 with Table 7).

Total CQA contents of at least 1%, usually of 2 to up to 10%, are found when using aqueous primary extracts and usually 3 to 15% when using alcoholic/aqueous primary extracts. Regardless of the primary extraction agent, the mono-CQA content of the total CQA content is at least 70%, for example at least 75%, and generally over 75% to 85%. The flavonoid content of extract fraction B is a maximum of 2%, preferably 0.02 to 1.5%, for aqueous and alcoholic/aqueous primary extracts. Regardless of the primary extraction agent, the mono-CQA/flavonoid quotient in fraction B is increased to values of between 4 and 35, for example between 5 and 35, as compared to the primary extract.

Examples of results for four fractionations of primary extracts from high-grade drugs carried out according to the invention (examples 8 to 11) are given in Table 7.

The extraction agent in the method according to the invention is a non-aqueous extraction agent, such as an organic solvent. Mentioned as examples are alcohols, ketones, esters, ethers, aromatics etc. Aliphatic alcohols and carboxylic acid esters are particularly suitable. These solvents can be used alone or as a mixture of the above compounds. In a particularly preferred embodiment, the extraction agent used is a mixture of 2-butanol and ethyl acetate.

In a preferred embodiment of the method, the crushed drug is extracted with water. The volume of the primary extract may then be reduced by approximately half under vacuum and is extracted at room temperature with a mixture of 2-butanol and ethyl acetate. The soluble fraction in the organic phase is separated and evaporated to become dry (fraction A). The extract contains the above-described quantities of CQA derivatives and flavonoids as well as other unidentified substances. The remaining aqueous fraction is also dried (fraction B).

In another preferred embodiment of the method, the crushed drug is first extracted with an alcoholic/aqueous extraction agent (primary extract). The primary or secondary alcohols have a chain length of C1 to C4. Disturbing plant constituents(for example chlorophylls, waxes) of alcoholic-aqueous primary extracts are removed from the evaporated aqueous phase with suitable, water-immiscible, non-polar, organic solvents such as, for example, hexane, petroleum ether or dichloromethane by extraction. The aqueous phase (primary extract) is extracted at room temperature with a mixture of 2-butanol and ethyl acetate. The soluble fraction in the solvent mixture is separated and evaporated to become dry (fraction A). The extract contains the above described quantities of CQA derivatives and flavonoids as well as further unidentified substances. The remaining aqueous fraction is also dried (fraction B).

The extract fractions A and B differ clearly in the content and composition of the CQA and the flavonoids from both the relevant initial primary extracts and in general from primary extracts of the prior art.

The resulting extract fractions A and B surprisingly have very different pharmacological action profiles. Extract fraction A is a powerful inhibitor of cholesterol biosynthesis and has a very high anti-oxidative capacity for the suppression of the formation of free radicals. It was found that the pharmacological effects are clearly higher than those of the primary extracts. On the other hand, unlike the primary extract or extract fraction B, fraction A has no effect or only very little effect in a test model for dyspepsia (s. Tables 4-6).

On the other hand, unlike the primary extract, extract fraction B has high activity in the dyspepsia model and does not show any significant inhibition of cholesterol biosynthesis. The anti-oxidative properties of fraction B are lower (cf. Tables 4-6 below).

The described extracts A and B can be processed and applied in common solid, semi-solid and liquid pharmaceutical forms and other forms of administration, such as, for example, in powders, solutions, suspensions, tablets, film-coated tablets, coated tablets, capsules, effervescent tablets, effervescent granules, chewable tablets and lozenges, suppositories, creams, ointments, gels. Common auxiliary agents may be used here for the respective form of administration, such as, for example, celluloses, silicas, lactose, synthetic polymers, salts, colorants, aromatics, fats, oils, surfactants, water and alcohols.

### EXAMPLE

The invention will be described in more detail in the following with reference to examples. However, the invention is not restricted to these examples.

The percentages and contents of the constituents determined in each case were measured as described in BRAND and WESCHTA 1991, Zeitschr. Phytother. 1991; 12: 15-21.

### Example 1a

300 g of an artichoke leaf drug (commercial drug A) were extracted by means of 2-stage maceration at 80-90° C. (5 hrs/3 hrs) with altogether 4.5 l of water. The two eluates were combined and evaporated to a volume of 2.5 l. The CQA and flavonoid contents were determined according to BRAND and WESCHTA 1991, Zeitschr. Phytother. 1991; 12: 15-21. The results are shown in Tables 2 and 3.

### Examples 2a and 3a

Commercial drugs B and C were treated in the same way as in example la and the contents determined accordingly. The results are shown in Tables 2 and 3.

### Example 1b

300 g of an artichoke leaf drug (commercial drug A) were extracted by means of five-hour percolation at 55-60° C. with 5 l of methanol/water (80/20 v/v). The eluates were combined. The total eluate was evaporated to approximately ⅓ of its volume, diluted 1:1 (v/v) with water and then washed 3× with 500 ml dichloromethane in each case. The organic phase was discarded. The CQA and flavonoid contents in the aqueous phase were determined according to BRAND and WESCHTA 1991, Zeitschr. Phytother. 1991; 12: 15-21. The results are shown in Tables 2 and 3.

### Examples 2b and 3b

Commercial drugs B and C were treated in the same way as in example 1b and the contents determined accordingly. The results are shown in Tables 2 and 3.

### Example 4

300 g of an artichoke leaf drug were extracted by means of 2-stage maceration at 80-90° C. (5 hrs/3 hrs) with altogether 4.5 l of water. The two eluates, which together contained approximately 124 g of dry substance, were combined and evaporated to a volume of 2.5 l. The CQA and flavonoid contents were determined according to BRAND and WESCHTA 1991, Zeitschr. Phytother. 1991; 12: 15-21. The results are shown in Tables 2 and 3.

### Example 5

300 g of an artichoke leaf drug from another batch (batch 2) were extracted by means of 2-stage maceration at 80-90° C. (5 hrs/3 hrs) -together with altogether 4.5 l of water. The two eluates, which together contained approximately 121 g of dry extract, were combined and evaporated to a volume of 2.5 l. The CQA and flavonoid contents were determined according to BRAND and WESCHTA 1991, Zeitschr. Phytother. 1991; 12: 15-21. The results are shown in Tables 2 and 3.

### Example 6

300 g of an artichoke leaf drug were extracted by means of five-hour percolation at 55-60° C. with 5 l of methanol/water (80/20 v/v). The eluates were combined. Together they contained 108 g of dry substance. The total eluate was evaporated to approximately ⅓ of its volume, diluted 1:1 (v/v) with water and then washed 3× in 500 ml of dichloromethane in each case. The organic phase was discarded. The aqueous phase contained 86 g of dry residue. The CQA and flavonoid contents were determined according to BRAND and WESCHTA 1991, Zeitschr. Phytother. 19.91; 12: 15-21. The results are shown in Tables 2 and 3.

### Example 7

300 g of an artichoke leaf drug (batch 2) were extracted by means of five-hour percolation at 55-60° C. with 5 l of methanol/water (80/20 v/v). The eluates were combined. Together they contained 85 g of dry extract. The total eluate was evaporated to approximately ⅓ of its volume, diluted 1:1 (v/v) with water and then washed 3× with 500 ml dichloromethane in each case. The organic phase was discarded. The aqueous phase contained 71 g of dry residue. The CQA and flavonoid contents were determined according to BRAND and WESCHTA 1991, Zeitschr. Phytother. 1991; 12: 15-21. The results are shown in Tables 2 and 3.

Table 2: Influence of drug quality and the choice of extraction agent on CQA and flavonoid contents in different drug batches and the extract batches produced therefrom (examples of commercial drugs A, B and C and from high-grade parent drugs)

| | Drug | | | | Methanolic/ | |
|---|---|---|---|---|---|---|
| | | Flavo- | Aqueous extract | | aqueous extract | |
| | CQA | noids | CQA | Flavonoids | CQA | Flavonoids |
| Example | (%) | (%) | (%) | (%) | (%) | (%) |
| Commercial | 0.69 | 0.21 | 1.54 | 0.46 | 2.48 | 0.71 |
| drug A | | | | | | |
| Commercial | 1.85 | 0.49 | 4.57 | 1.11 | 6.30 | 1.57 |
| drug B | | | | | | |
| Commercial | 4.55 | 0.80 | 10.94 | 2.13 | 15.07 | 2.82 |
| drug C | | | | | | |
| Examples | 6.21 | 1.18 | 10.06 | 1.98 | 18.83 | 2.79 |
| 4 and 6 | | | | | | |
| Examples | 4.94 | 0.91 | 10.53 | 1.81 | 19.14 | 2.89 |
| 5 and 7 | | | | | | |

The CQA and flavonoid contents of primary artichoke leaf extracts are dependant on the parent drug content and the choice of extraction agent. Depending on the type, origin, harvesting time, cultivation, drying and storage conditions, high-grade artichoke leaf drugs can contain 1 to 7% CQA and 0.2 to 1.2% flavonoids, whereby the mono-CQA accounts for a content of 40 to 60% of the total CQA content. Tables 2 and 3 show the results of investigations on primary extracts produced from qualitatively different drugs with different extraction agents. The maximum CQA content of aqueous and methanolic-aqueous extracts is 11% and 20%, respectively. The flavonoid content of aqueous extracts may be up to 2,5% and that of alcoholic/aqueous extracts up to 3%.

Table 3: Proportion of mono-CQA in the total CQA contents and mono-CQA/flavonoid quotient in different drug batches and the associated extract batches (examples of commercial drugs A, B and C and of high-grade parent drugs)

| | Drugs | | | | Methanolic/aqueous | |
|---|---|---|---|---|---|---|
| | Proportion | | Aqueous extract | | extract | |
| | of mono- | Mono- | Proportion | Mono- | Proportion | Mono- |
| | CQA in CQA | CQA/ | of mono- | CQA/ | of mono- | CQA/ |
| Example | (%) | flavonoids | CQA in CQA | flavonoids | CQA in CQA | flavonoids |
| Commercial | 57 | 1.87 | 65 | 2.41 | 59 | 2.06 |
| drug A | | | | | | |
| Commercial | 49 | 1.85 | 49 | 2.02 | 51 | 2.05 |
| drug B | | | | | | |
| Commercial | 46 | 2.62 | 53 | 2.72 | 49 | 2.29 |
| drug C | | | | | | |
| Examples 4 | 45 | 2.37 | 54 | 2.48 | 44 | 2.41 |
| and 6 | | | | | | |
| Examples 5 | 50 | 2.72 | 60 | 3.14 | 49 | 2.65 |
| and 7 | | | | | | |

The mono-CQA proportion of the total CQA content may vary between 49 and 65% with aqueous extracts and between 44 and 59% with methanolic/aqueous extracts. In the case of extraction with water, the mono-CQA/flavonoid quotient in the extract is in the range of 2.0 to 3.2 and in the case of extraction with methanol/water, it is between 2.0 and 2.7. The two parameters almost exactly reflect the ratios in the parent drug (Table 3). Therefore it can be established that both aqueous and aqueous/alcoholic extracts are almost qualitatively identical as compared to each other and to the parent drug.

### Example 8

The primary extraction according to example 4 was followed by 5× liquid-liquid extraction with 600 ml ethyl acetate/2-butanol (60/40 v/v) in each case for 3 to 5 min at room temperature. The organic phases were combined, evaporated to dryness under vacuum at 40° C., then dried for 2 h under vacuum at 60° C. 18.65 g of dry extract were obtained (extract fraction A).

The organically extracted aqueous lower phase was evaporated under vacuum at 40° C. and dried for 2 h under vacuum at 60° C. 93.45 g of dry extract were obtained (extract fraction B).

### Example 9

The primary extraction according to example 5 was followed by 5× liquid-liquid extraction with 600 ml ethyl acetate/2-butanol (60/40 v/v) in each case for 3 to 5 min at room temperature. The organic phases were combined, evaporated to dryness under vacuum at 40° C., then dried for 2 h under vacuum at 60° C. 11 g of dry extract were obtained (extract fraction A).

The organically extracted aqueous lower phase was evaporated under vacuum at 40° C. and dried for 2 h under vacuum at 60° C. 96 g of dry extract were obtained (extract fraction B).

### Example 10

The aqueous phase of example 6 was evaporated under vacuum to approximately ⅓ its volume and extracted 5× with 500 ml of ethyl acetate/2-butanol (60/40 v/v) in each case for 3 to 5 min at room temperature. The organic phases were combined. The solvent was drawn off under vacuum at 40° C. The residue was then dried for 2 h under vacuum at 60° C. 16 g of dry extract were obtained (extract fraction A).

The organically extracted aqueous lower phase was evaporated under vacuum at 40° C. and then dried for 2 h under vacuum at 60° C. 61 g of dry extract were obtained (extract fraction B)

### Example 11

The aqueous phase of example 7 was evaporated under vacuum to approximately ⅓ its volume and extracted 5× with 500 ml ethyl acetate/2-butanol (60/40 v/v) in each case for 3 to 5 min at room temperature. The organic phases were combined. The solvent was drawn off under vacuum at 40° C. The residue was then dried for 2 h under vacuum at 60° C. 11 g of dry extract were obtained (extract fraction A).

The organically extracted aqueous lower phase was evaporated under vacuum at 40° C. and then dried for 2 h under vacuum at 60° C. 57 g of dry extract were obtained (extract fraction B).

Pharmacological Investigations:

Inhibition of Cholesterol Biosynthesis

The determination of the inhibition of cholesterol biosynthesis was performed according to MERTENS K. et al., Toxic. in vitro 1993; 7: 439-441.

TABLE 4
Inhibition of cholesterol biosynthesis in rat
hepatocytes with applied concentrations
of 0.1 mg/ml and 1.0 mg/ml

| | | Inhibitory action at | Inhibitory action |
|---|---|---|---|
| | | a concentration of | at a concentration |
| Example | Substance | 0.1 mg/ml | of 1.0 mg/ml |
| 4 and 8 | Primary | 13% | 90% |
| | extract | | |
| | Fraction A | 86% | 99% |
| | Fraction B | 0% | 0% |
| 5 and 9 | Primary | 5% | 25% |
| | extract | | |
| | Fraction A | 15% | 91% |
| | Fraction B | 0% | 21% |
| 6 and 10 | Primary | 0% | 90% |
| | extract | | |
| | Fraction A | 32% | 99% |
| | Fraction B | 6% | 16% |
| 7 and 11 | Primary | 12% | 19% |
| | extract | | |
| | Fraction A | 46% | 97% |
| | Fraction B | 13% | 18% |

Anti-Oxidative Capacity

The determination of the anti-oxidative capacity was performed according to GUGELER N., Peroxidationsreaktionen bei der Artherogenese: Modulatoren der LDL-Oxidation und der Radikal-bildung von Makrophagen, Dissertation 1997, Faculty of Biology at the University of Tubingen, Germany.

TABLE 5
Inhibition of horseradish peroxidase and xanthine
oxidase at an applied concentration of 0.3 μg/batch

| | | Inhibition of | |
|---|---|---|---|
| | | horseradish | Inhibition of |
| Examples | Substance | peroxidase | xanthine oxidase |
| 4 and 8 | Primary | 37% | 26% |
| | extract | | |
| | Fraction A | 57% | 64% |
| | Fraction B | 35% | 26% |
| 5 and 9 | Primary | 53% | 33% |
| | extract | | |
| | Fraction A | 75% | 69% |
| | Fraction B | 43% | 29% |
| 6 and 10 | Primary | 50% | 49% |
| | extract | | |
| | Fraction A | 85% | 75% |
| | Fraction B | 36% | 39% |
| 7 and 11 | Primary | 52% | 47% |
| | extract | | |
| | Fraction A | 86% | 76% |
| | Fraction B | 41% | 35% |

Anti-Dyspeptic Action The determinations for the anti-dyspeptic action were

performed according to BONISCH H. et al., Brit. J. Pharmacol. 1993; 108: 436-442.

TABLE 6
¹⁴C-guanidinium uptake in neuroblastoma cells
following the application of different test
substances

| | | ¹⁴C guanidinium uptake |
|---|---|---|
| Examples | Substance | Control (=100%) |
| 4 and 8 | Primary extract | 22 |
| | Fraction A | 110 |
| | Fraction B | 21 |
| 5 and 9 | primary extract | 37 |
| | Fraction A | 123 |
| | Fraction B | 38 |
| 6 and 10 | primary extract | 74 |
| | Fraction A | 130 |
| | Fraction B | 38 |
| 7 and 11 | primary extract | 28 |
| | Fraction A | 101 |
| | Fraction B | 25 |

TABLE 7
Mono-, di- and total CQA and flavonoid contents of
the primary extracts and associated extract fractions from
examples 4 to 11

| | | | | | | Proportion | |
|---|---|---|---|---|---|---|---|
| | | Total | Mono- | Di- | | of mono- | Ratio |
| | | CQA | CQA | CQA | Flavonoids | in total | mono-CQA/ |
| Example | Substance | (%) | (%) | (%) | (%) | CQA (%) | flavonoids |
| 4 | Primary | 9.74 | 5.39 | 4.35 | 2.20 | 55.3 | 2.45 |
| and 8 | extract | | | | | | |
| | Fraction A | 25.99 | 4.41 | 21.58 | 13.29 | 16.9 | 0.33 |
| | Fraction B | 6.32 | 4.83 | 1.49 | 0.76 | 76.4 | 6.36 |
| 5 | Primary | 10.44 | 6.31 | 4.13 | 2.00 | 60.4 | 3.16 |
| and 9 | extract | | | | | | |
| | Fraction A | 25.77 | 6.26 | 19.51 | 17.50 | 24.3 | 0.36 |
| | Fraction B | 7.67 | 6.07 | 1.60 | 0.24 | 79.1 | 25.29 |
| 6 | Primary | 18.84 | 8.32 | 10.52 | 2.79 | 44.2 | 2.40 |
| and | extract | | | | | | |
| 10 | Fraction A | 47.62 | 6.38 | 41.24 | 10.90 | 13.4 | 0.59 |
| | Fraction B | 10.38 | 8.12 | 2.26 | 1.41 | 78.2 | 5.76 |
| 7 | Primary | 19.14 | 9.37 | 9.77 | 2.89 | 48.9 | 2.65 |
| and | extract | | | | | | |
| 11 | Fraction A | 42.48 | 6.33 | 36.15 | 17.52 | 14.9 | 0.36 |
| | Fraction B | 11.26 | 9.00 | 2.26 | 0.34 | 79.9 | 26.47 |

1. Extract of artichoke leaves (Cynarae folium) containing:
a total CQA content of mono-CQA and di-CQA of at least 6%, preferably 10 to 50%, relative to the total quantity of the extract,
a flavonoid content of at least 3%, preferred 4%, preferably 7 to 30%, relative to the total quantity of the extract.

2. Extract according to claim 1 having a content of mono-CQA of less than 30%, preferably 3 to 30%, particularly preferred 10 to 30%, relative to the total CQA content.

3. Extract according to claim 1 or 2 having a ratio of mono-CQA content to flavonoid content of less than 1.

4. Method for the production of an extract of artichoke leaves (Cynarae folium) according to claims 1 to 3, comprising the steps of:
liquid-liquid-extraction of a primary extract from fresh or dried artichoke leaves obtained by extraction with water or by extraction with an organic solvent from the series of alcohols, ketones, esters, ethers, preferably methanol, ethanol or mixtures of these compounds with water, with a non-aqueous organic solvent from the series of alcohols, ketones, esters, ethers, aromatics or mixture of these compounds, and
obtaining the organic phase

5. Method according to claim 4, whereby the organic solvent for the extraction of the primary extract is a mixture of 2-butanol and ethyl acetate.

6. Method according to claim 4 or 5 comprising the preceding steps of:
concentrating the primary extract volume or adding water to the primary extract until the extract contains more than 50% water.
washing the extract with a non-polar, water-immiscible solvent, preferably one from the series of alkanes, alkenes, ethers, esters or chlorinated hydrocarbons; separating and disposing of the organic phase.

7. Extract of artichoke leaves (Cynarae folium) containing:
a total CQA content of mono-CQA and di-CQA of at least 1%, preferably 2 to 15%, relative to the total quantity of the extract,
a flavonoid content of a maximum of 2%, preferably 0.02 to 1.5%, relative to the total quantity of the extract, a content of mono-CQA of at least 70%, preferably at least 75%, relative to the total CQA content.

8. Extract according to claim 7 having a ratio of mono-CQA content to flavonoid content of between 4 and 35, preferably 5 to 35.

9. Method for the production of an extract of artichoke leaves (Cynarae folium) according to claim 7 or 8 comprising the steps of:
liquid-liquid-extraction of a primary extract from fresh or dried artichoke leaves obtained by extraction with water or by extraction with an organic solvent from the series of alcohols, ketones, esters, ethers, preferably methanol, ethanol or mixtures of these compounds with water, with a non-aqueous organic solvent from the series of alcohols, ketones, esters, ethers, aromatics or mixture of these compounds, and
obtaining the aqueous phase.

10. Method according to claim 9, whereby the organic solvent for the extraction of the primary extract is a mixture of 2-butanol and ethyl acetate.

11. Method according to claim 9 or 10 comprising the preceding steps of:
concentrating the primary extract volume or adding water to the primary extract until the extract contains more than 50% water,
washing the extract with a non-polar, water-immiscible solvent, preferably one from the series of alkanes, alkenes, ethers, esters or chlorinated hydrocarbons; separating and disposing of the organic phase.

12. Use of the extracts according to one of claims 1 to 3 and 7 to 8 for the production of medicinal products.

13. Use of the extracts according to one of claims 1 to 3 and 7 to 8 for the production of foodstuffs.

14. Use of the extracts according to one of claims 1 to 3 and 7 to 8 for the production of dietetic foods.

15. Use of the extracts according to one of claims 1 to 3 and 7 to 8 for the production of cosmetics.

16. Use of the extracts according to one of claims 1 to 3 for the production of a preparation according to claims 12 to 15 having an anti-oxidative, cell- and organ-protecting action.

17. Use of the extract according to one of claims 1 to 3 for the production of a preparation according to claims 12 to 15 for the treatment and prophylaxis of hypercholesterolaemia and hyperlipidaemia.

18. Use of the extract according to one of claims 1 to 3 for the production of a preparation according to claims 12 to 15 for the treatment and prophylaxis of cardiovascular diseases and arteriosclerosis.

19. Use of the extract according to one of claims 1 to 3 for the production of a preparation according to claims 12 to 15 for the treatment and prophylaxis of dementia.

20. Use of the extract according to one of claims 7 to 8 for the production of a preparation according to claims 12 to 15 having an anti-serotonergic, spasmolytic, anticholestatic, choleretic, antiemetic and prokinetic action.

21. Use of the extract according to one of claims 7 to 8 for the production of a preparation according to claims 12 to 15 to increase vesicular secretion and lipolysis, for the treatment of dyspepsia and for the treatment of IBS (irritable bowel syndrome).
